(19) United States
(12) Patent Application Publication
(10) Pub. No.: US 2026/0197134 A1
(43) Pub. Date: Jul. 9, 2026

(54) CARRIER PHASE POSITIONING CONFIGURATION

(71) Applicant: Lenovo (Singapore) Pte. Limited, Singapore (SG)

(72) Inventors: Robin Rajan Thomas, Bad Nauheim (DE); Abir Ben Hadj Fredj, Wiesbaden (DE); Colin Frank, Park Ridge, IL (US)

(73) Assignee: Lenovo (Singapore) Pte. Limited, Singapore (SG)

(21) Appl. No.: 19/134,669

(22) PCT Filed: Jan. 12, 2024
(86) PCT No.: PCT/IB2024/050351

§ 371 Date: May 30, 2025

Related U.S. Application Data
(60) Provisional application No. 63/480,195, filed on Jan. 17, 2023.

(51) Int. Cl. H04L 5/00

(52) U.S. Cl. CPC H04L 5/0048

(57) ABSTRACT

Various aspects of the present disclosure relate to an apparatus for carrier phase positioning configuration. The apparatus, such as a target UE, receives one or more carrier phase positioning configurations that include at least one of positioning reference signal (PRS) parameters or transmitter error types. The target UE also receives one or more PRS transmissions on which carrier phase measurements are performed based at least in part on the one or more carrier phase positioning configurations.

### RELATED APPLICATION

This application claims priority to U.S. Provisional Application Ser. No. 63/480,195 filed Jan. 17, 2023 entitled “Carrier Phase Positioning Configuration,” the disclosure of which is incorporated by reference herein in its entirety.

### TECHNICAL FIELD

The present disclosure relates to wireless communications, and more specifically to carrier phase positioning.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system enables UE-assisted and UE-based positioning methods in the third generation partnership project (3GPP) positioning framework. However, direct UE-to-UE range, distance, and orientation determinations are not currently supported, which would facilitate relative positioning applications across other services, such as for vehicle-to-everything (V2X), public safety, industrial Internet of things (IIoT), commercial, and other applications.

### SUMMARY

The present disclosure relates to methods, apparatuses, and systems that support carrier phase positioning configuration, and support carrier phase measurements on the uplink and downlink. By utilizing the described techniques, carrier phase measurements can be utilized to determine the distance between two network nodes or entities, as well as the absolute location of a target-UE. In addition, the use of carrier phase measurements does not require large bandwidths as compared to other positioning techniques, which generally require fine time or angular resolution for improved location performance. The described techniques for carrier phase positioning can therefore be leveraged in bandwidth limited scenarios. The compensation of all possible carrier phase positioning impairments that affect the positioning performance is also taken into consideration in order to achieve the desired accuracy levels.

Aspects of the disclosure are directed to enhanced configuration mechanisms and procedures to enable carrier phase positioning between devices, or between a device and network nodes. Aspects also take into account procedures to support timely and accurate downlink, uplink, and sidelink carrier phase measurements between one or more multiple devices and/or a target-UE. Aspects also include procedures to support on-demand positioning reference signal (PRS) request and response signaling in order to perform updated downlink, uplink, and sidelink carrier phase measurements. Aspects of the described techniques also mitigate the effect of impairments caused by other downlink signals and channels on downlink-based carrier phase measurements, and reduce the time gap between performing downlink and sidelink carrier phase measurements via an aligned configuration on the Uu and sidelink (PC5) interfaces.

In some implementations of the method and apparatuses described herein, a target UE receives a first signaling of one or more carrier phase positioning configurations that include at least one of PRS parameters, transmitter error types, an integer ambiguity, or integer ambiguity quality metrics. The target UE also receives a second signaling of one or more PRS transmissions on which carrier phase measurements are performed based at least in part on the one or more carrier phase positioning configurations.

Some implementations of the method and apparatuses described herein may further include the target UE determines location information of a location of the UE based at least in part on the carrier phase measurements. The one or more carrier phase positioning configurations include PRS resources to perform at least one of uplink carrier phase measurements, downlink carrier phase measurements, or sidelink carrier phase measurements according to a measured first arrival path. The PRS parameters include at least one of a number of symbols, a resource element (RE) offset, a PRS comb size, a periodicity, a muting pattern, repetitions, a subcarrier spacing, an integer ambiguity value range, an integer confidence interval, or carrier information. The carrier phase measurements are associated with measurements performed on PRS time-frequency resources that span at least one of one or more carriers, one or more bandwidth parts (BWPs), or one or more resource pools within a BWP. The bi-directional carrier phase measurements are based at least in part on the carrier phase measurements performed at a transmitter and a receiver in a single positioning session. The target UE determines the carrier phase measurements based at least in part on a carrier frequency, subcarrier spacing, or a propagation delay of a received PRS of the one or more PRS transmissions. The transmitter error types include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. The target UE requests at least one of a downlink carrier phase configuration or a sidelink carrier phase configuration using location management function (LMF)-initiated or UE-initiated on-demand PRS. The target UE receives a configuration of a dedicated prioritization window of additional carrier phase measurements based on a set of PRS resources associated with one or more downlink signals and channels. The configuration of the dedicated prioritization window of the additional carrier phase measurements is configured by at least one of a network entity or a configuration entity. The different priority states of respective different positioning techniques are defined with respect to a PRS utilized for the different positioning techniques. A downlink-PRS used for performing reference signal time difference (RSTD) measurements has a higher priority state relative to a priority state of the carrier phase measurements. The carrier phase measurements have a higher priority state relative to a priority state of a downlink-PRS used for performing RSTD measurements. The target UE measures signal interference caused by shared downlink signals and channels, and transmits the measured signal interference to a configuration entity that determines a degradation to a downlink-PRS for downlink carrier phase measurements. For a carrier phase measurement configuration, a time gap between performing a downlink carrier phase measurement and a sidelink carrier phase measurement is minimized by using a joint downlink and sidelink measurement window.

In some implementations of the method and apparatuses described herein, a configuration entity receives a first signaling as integer ambiguity information of prior carrier phase measurements based at least in part on one or more PRS transmissions. The configuration entity also transmits a second signaling as a carrier phase positioning configuration based at least in part on the integer ambiguity information, the carrier phase positioning configuration including at least one of PRS parameters, transmitter error types, an integer ambiguity, or integer ambiguity quality metrics.

Some implementations of the method and apparatuses described herein may further include the configuration entity determines whether to transmit the second signaling of the carrier phase positioning configuration as one of a standalone carrier phase positioning configuration or a joint carrier phase positioning configuration. The carrier phase positioning configuration includes PRS resources to perform at least one of uplink carrier phase measurements, downlink carrier phase measurements, or sidelink carrier phase measurements. The PRS parameters include at least one of a number of symbols, a RE offset, a PRS comb size, a periodicity, a muting pattern, repetitions, a subcarrier spacing, an integer ambiguity value range, an integer confidence interval, or carrier information. The carrier phase measurements are performed on PRS time-frequency resources that span at least one of one or more carriers, one or more BWPs, or one or more resource pools within a BWP. The bi-directional carrier phase measurements are based at least in part on the carrier phase measurements performed at a transmitter and a receiver in a single positioning session. The carrier phase measurements are based at least in part on a carrier frequency, subcarrier spacing, or a propagation delay of a received PRS. The transmitter error types include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. For a carrier phase measurement configuration, a time gap between performing a downlink carrier phase measurement and a sidelink carrier phase measurement is minimized by use of a joint downlink and sidelink measurement window.

In some implementations of the method and apparatuses described herein, a base station (e.g., a gNB, or location server) transmits a first signaling as a request for one or more sounding reference signal (SRS) configurations to perform carrier phase measurements. The base station receives a second signaling as a response of the one or more SRS configurations to perform the carrier phase measurements at multiple network entities. The base station receives a third signaling as UE transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin.

Some implementations of the method and apparatuses described herein may further include the base station transmits an activation SRS transmission command for carrier phase to the multiple network entities, and transmits a deactivation SRS transmission command upon completion of SRS transmission.

### BRIEF DESCRIPTION OF THE DRAWINGS

FIG. 1 illustrates an example of a wireless communications system that supports carrier phase positioning configuration in accordance with aspects of the present disclosure.

FIG. 2 illustrates an example of a system for NR beam-based positioning as related to carrier phase positioning configuration in accordance with aspects of the present disclosure.

FIG. 3 illustrates an example of absolute and relative positioning scenarios as related to carrier phase positioning configuration in accordance with aspects of the present disclosure.

FIG. 4 illustrates an example of a multi-cell round trip time (RTT) procedure as related to carrier phase positioning configuration in accordance with aspects of the present disclosure.

FIG. 5 illustrates an example of a system for relative range estimation using a gNB RTT positioning framework as related to carrier phase positioning configuration in accordance with aspects of the present disclosure.

FIG. 6 illustrates an example of a UE-based carrier phase positioning configuration, which supports carrier phase positioning configuration in accordance with aspects of the present disclosure.

FIG. 7 illustrates an example of a UE-assisted carrier phase positioning configuration, which supports carrier phase positioning configuration in accordance with aspects of the present disclosure.

FIG. 8 illustrates an example of a NG-RAN assisted carrier phase positioning configuration, which supports carrier phase positioning configuration in accordance with aspects of the present disclosure.

FIGS. 9 and 10 illustrate an example of a block diagram of devices that supports carrier phase positioning configuration in accordance with aspects of the present disclosure.

FIGS. 11-16 illustrate flowcharts of methods that support carrier phase positioning configuration in accordance with aspects of the present disclosure.

### DETAILED DESCRIPTION

A wireless communications system enables UE-assisted and UE-based positioning methods in the 3GPP positioning framework. However, direct UE-to-UE range, distance, and orientation determinations are not supported in a conventional system. Aspects of the present disclosure takes into account the signaling and behaviors to support carrier phase positioning that corresponds to NR and the 3GPP positioning framework. A conventional solution for reducing integer ambiguity using a virtual phase measurement to determine the location of a device using carrier phase measurements does not take into account any quality metrics associated with the integer ambiguity, or provide for any signaling support for downlink, uplink, and sidelink carrier phase measurements.

In the context of positioning, a variety of positioning techniques can be utilized to obtain useful positioning performance (e.g., useful accuracy and/or low latency positioning). Examples of Uu and sidelink positioning techniques include AoA, RTT, TDoA, and so forth. However, carrier phase positioning provides the tight accuracy requirements in certain Uu and sidelink scenarios, including IIOT and other indoor environments. This disclosure provides novel techniques to realize the support of carrier phase positioning between devices, network entities, and network nodes within a network via configuration enhancements to enable the accurate and timely downlink, uplink, and sidelink measurement of the carrier phase in different scenarios and deployments.

The present disclosure provides solutions to support carrier phase measurement and processing configurations to enable UE-based, UE-assisted, and NG-RAN assisted carrier phase measurements. An aspect of the described solutions involves the efficient update of carrier phase PRS configuration via the on-demand procedure, while another aspect accounts for the issue of prioritization and interference management between downlink PRS for downlink-based carrier phase measurement with other downlink signals and channels within the same downlink BWP. Another aspect of the solution considers an efficient configuration to support both downlink and sidelink carrier phase measurements.

In aspects of carrier phase positioning configuration described herein, one or more responder and/or target UE devices are configured to perform standalone carrier phase measurements or joint carrier phase measurements with other positioning measurements over Uu or sidelink (PC5) interfaces based on a received PRS configuration. In other implementations, on-demand PRS for downlink-based carrier phase measurements is supported in order to update the PRS configuration related downlink-based carrier phase measurements for both UE-initiated and LMF-initiated on-demand PRS requests. In other implementations, accurate downlink-based carrier phase configurations are supported in the presence of other downlink signals and channels without the aid of a measurement gap. In other implementations, the time gap between performing downlink and sidelink carrier phase measurements is minimized via an appropriate time-based configuration.

The present disclosure relates to methods, apparatuses, and systems that support carrier phase positioning configuration, and support carrier phase measurements on the uplink, downlink, and sidelink. By utilizing the described techniques, carrier phase measurements can be utilized to determine the distance between two network nodes or entities, as well as the absolute location of a target-UE. In addition, the use of carrier phase measurements does not require large bandwidths as compared to other positioning techniques, which generally require fine time or angular resolution for improved location performance. The described techniques for carrier phase positioning can therefore be leveraged in bandwidth limited scenarios. The compensation of all possible carrier phase positioning impairments that affect the positioning performance is also taken into consideration in order to achieve the desired accuracy levels.

Aspects of the present disclosure are described in the context of a wireless communications system. Aspects of the present disclosure are further illustrated and described with reference to device diagrams and flowcharts.

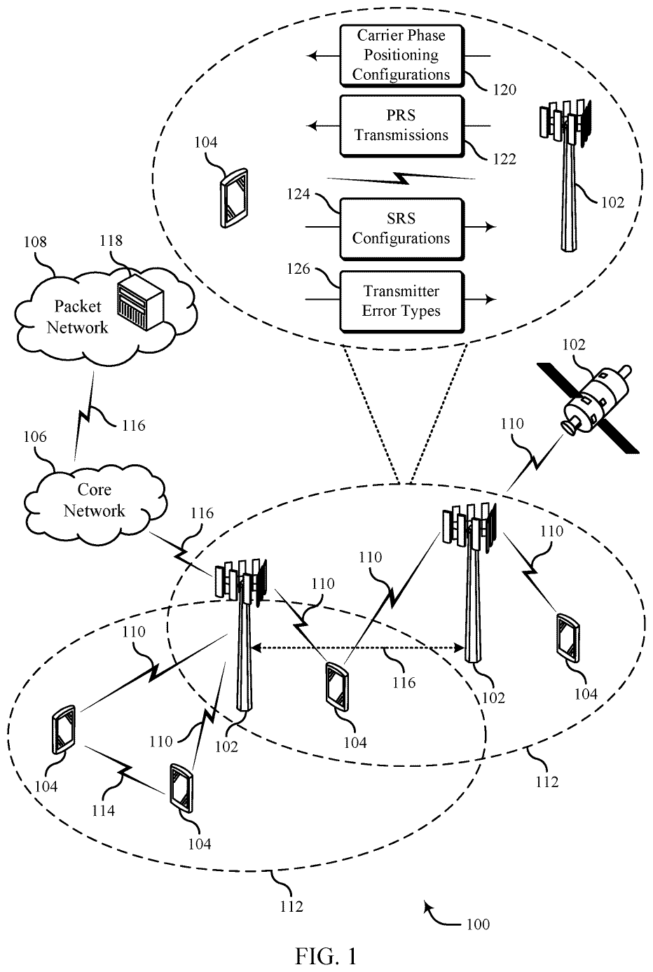

FIG. 1 illustrates an example of a wireless communications system 100 that supports carrier phase positioning configuration in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)), a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 (e.g., implemented as a configuration entity, base station, gNB, location server) and the UEs 104 (e.g., a target UE) are operable to implement various aspects of carrier phase positioning configuration, as described herein. Either of the network entity 102 (e.g., a configuration entity, a location server) and/or a target UE device may be implemented in the wireless communications system 100 as a UE 104, an anchor UE, a target UE, a reference UE, a positioning reference unit (PRU), a base station, a gNB, a roadside unit, an unmanned or uncrewed ariel vehicle (UAV) (e.g., a drone), and/or as any other type of network devices or entities performing procedures for carrier phase positioning configuration. For instance, target UE 104 receives one or more carrier phase positioning configurations 120 that include PRS parameters, transmitter error types, an integer ambiguity, and/or integer ambiguity quality metrics. The target UE 104 also receives one or more PRS transmissions 122 on which carrier phase measurements are performed based at least in part on the one or more carrier phase positioning configurations.

Alternatively, or in addition, the network entity 102 (e.g., a base station, gNB, or location server) transmits a request for one or more SRS configurations to perform carrier phase measurements, and receives a response of the one or more SRS configurations 124 to perform the carrier phase measurements at multiple network entities. The network entity also receives UE transmitter error types 126 that include an initial transmitter phase offset or a group of transmitter phase offsets if a transmitter phase offset is within a variable margin, a transmitter antenna reference point location error, and/or a combination of the transmitter antenna reference point location error and within the variable margin.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows:

| Positioning Error | Commercial | IIOT |
|---|---|---|
| Horizontal Positioning | (<1 m) for | (<0.2 m) for 90% of UEs; |
| | 90% of UEs | |
| Vertical Positioning | (<3 m) for | (<1 m) for 90% of UEs |
| | 90% of UEs | |
| Physical layer latency for | (<10 ms) | (<10 ms) |
| position estimation of UE | | |
| End-to-End Latency for | (<100 ms) | (<100 ms, in the order |
| position estimation of UE | | of 10 ms is desired) |

The supported positioning techniques in Release 16 are listed in Table 1.

TABLE T1
Supported Rel-16 UE Positioning Methods

| | UE- | UE-assisted, | NG-RAN | |
|---|---|---|---|---|
| Method | based | LMF-based | node assisted | SUPL |
| A-GNSS | Yes | Yes | No | Yes (UE-based |
| | | | | and UE-assisted) |
| OTDOA ^{Notes1, 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note 1}:
This includes TBS positioning based on PRS signals.
^{Note 2}:
In this version of the specification only observed time different of arrival (OTDOA) based on LTE signals is supported.
^{Note 4}:
This includes Cell-ID for NR method.
^{Note 5}:
In this version of the specification only for TBS positioning based on Metropolitan Beacon System (MBS) signals.

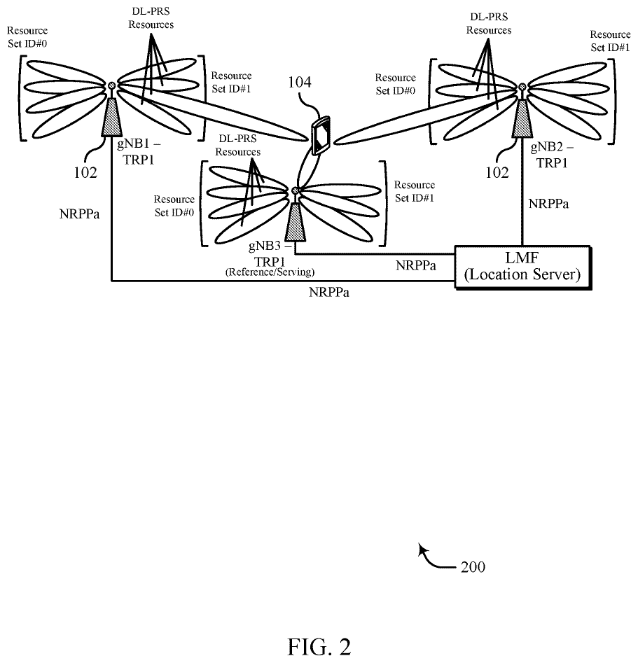

Separate positioning techniques as indicated in Table 1 can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per transmission reception point (TRP), where a TRP may include a set of one or more beams. A conceptual overview is illustrated in FIG. 2.

FIG. 2 illustrates an example of a system 200 for NR beam-based positioning as related to carrier phase positioning configuration in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (e.g., a TRP). Similarly, UE positioning measurements, such as RSTD and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location.

Tables 2 and 3 show the reference signal (RS) to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, wireless local area network (WLAN), and Bluetooth technologies for performing target device (UE) positioning.

TABLE T2
UE measurements to enable RAT-
dependent positioning techniques.

| | | To facilitate support |
|---|---|---|
| DL/UL Reference | | of the positioning |
| Signals | UE Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS / | UE Rx-Tx time difference | Multi-RTT |
| Rel. 16 SRS for | | |
| positioning | | |
| Rel. 15 SSB / | SS-RSRP(RSRP for RRM), | NR E-CID |
| CSI-RS for RRM | SS-RSRQ(for RRM), | |
| | CSI-RSRP (for RRM), | |
| | CSI-RSRQ (for RRM), | |
| | SS-RSRPB (for RRM) | |

TABLE T3
gNB measurements to enable RAT-dependent
positioning techniques.

| | | To facilitate support |
|---|---|---|
| DL/UL Reference | | of the positioning |
| Signals | gNB Measurements | techniques |
| Rel. 16 SRS for | UL RTOA | UL-TDOA |
| positioning | | |
| Rel. 16 SRS for | UL SRS-REFERENCE | UL-TDOA, UL-AoA, |
| positioning | SIGNAL RECEIVED | Multi-RTT |
| | POWER (RSRP) | |
| Rel. 16 SRS for | gNB Rx-Tx time | Multi-RTT |
| positioning, Rel. 16 | difference | |
| DL PRS | | |
| Rel. 16 SRS for | AoA and ZoA | UL-AoA, Multi-RTT |
| positioning | | |

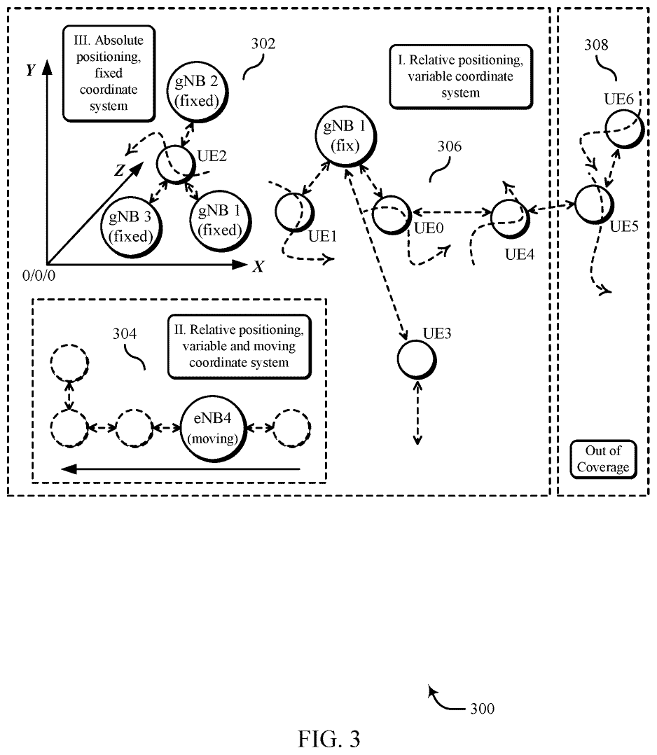

FIG. 3 illustrates an example 300 of absolute and relative positioning scenarios as related to carrier phase positioning configuration in accordance with aspects of the present disclosure. The network devices described with reference to example 300 may use and/or be implemented with the wireless communications system 100 and include UEs 104 and network entities 102 (e.g., eNB, gNB). The example 300 is an overview of absolute and relative positioning scenarios as defined in the architectural (stage 1) specifications using three different coordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

The relative positioning, variable and moving coordinate system at 304 may support relative lateral position accuracy of 0.1 meters between UEs supporting V2X applications, and may support relative longitudinal position accuracy of less than 0.5 meters for UEs supporting V2X applications for platooning in proximity. The relative positioning, variable coordinate system at 306 may support relative positioning between one UE and positioning nodes within 10 meters of each other. The relative positioning, variable coordinate system at 306 may also support vertical location of a UE in terms of relative height/depth to local ground level.

Various RAT-dependent positioning techniques are supported in Release 16 and Release 17, such as DL-TDoA, DL-AoD, Multi-RTT, enhanced cell-ID (E-CID)/NR E-CID, UL-TDoA, and UL-AoA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs. The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

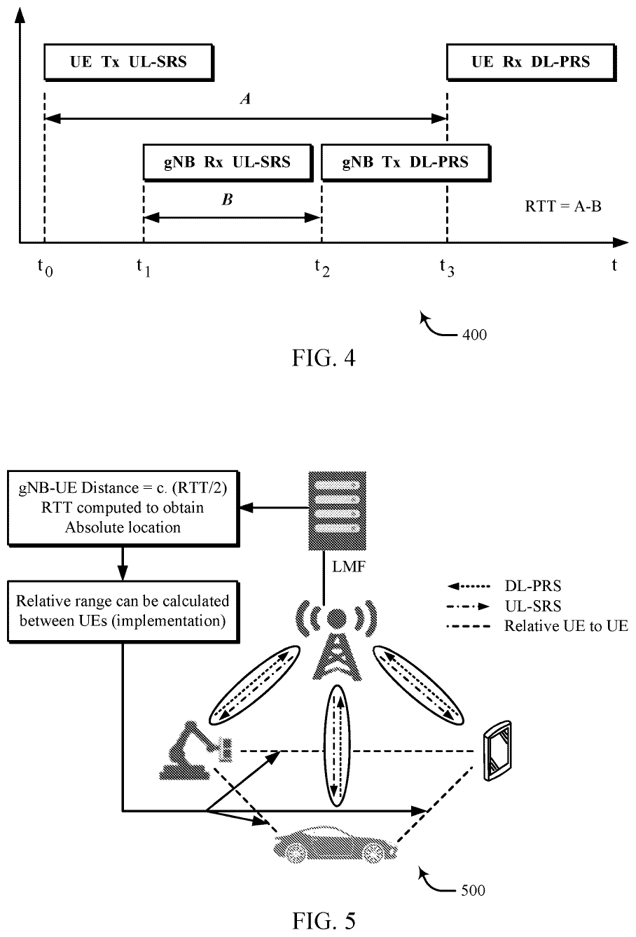

FIG. 4 illustrates an example 400 of a multi-cell RTT procedure as related to carrier phase positioning configuration in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink SRS RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in Table 1.

FIG. 5 illustrates an example of a system 500 for relative range estimation using a gNB RTT positioning framework as related to carrier phase positioning configuration in accordance with aspects of the present disclosure. The system 500 illustrates the relative range estimation using the existing single gNB RTT positioning framework. The location server (e.g., LMF) can configure measurements to the different UEs, and then the target UEs can report their measurements in a transparent way to the location server. The location server can compute the relative distance between two UEs. This approach is high in latency and is not an efficient method in terms of procedures and signaling overhead.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-relative time-of-arrival (RTOA) (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, terrestrial beacon system (TBS) positioning, and motion sensor positioning. Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, Global Navigation Satellite System (GLONASS), and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and PRSs. The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different downlink measurements used for RAT-dependent positioning techniques include including DL PRS-RSRP, DL RSTD and UE Rx-Tx Time Difference. The following measurement configurations may be used: 4 Pair of DL RSTD measurements can be performed per pair of cells, and each measurement is performed between a different pair of DL PRS Resources/Resource Sets with a single reference timing; 8 DL PRS RSRP measurements can be performed on different DL PRS resources from the same cell.

The DL PRS reference signal received power (DL PRS-RSRP) is defined as the linear average over the power contributions (in [W]) of the resource elements that carry DL PRS reference signals configured for RSRP measurements within the considered measurement frequency bandwidth. For frequency range 1, the reference point for the DL PRS-RSRP is the antenna connector of the UE. For frequency range 2, DL PRS-RSRP is measured based on the combined signal from antenna elements corresponding to a given receiver branch. For frequency range 1 and 2, if receiver diversity is in use by the UE, the reported DL PRS-RSRP value is not lower than the corresponding DL PRS-RSRP of any of the individual receiver branches. DL PRS-RSRP is applicable for RRC_CONNECTED intra-frequency and RRC_CONNECTED inter-frequency.

The DL RSTD is the downlink relative timing difference between the positioning node j and the reference positioning node i, defined as T_{SubframeRxj}-T_{SubframeRxi}, where T_{SubframeRxj} is the time when the UE receives the start of one subframe from positioning node j, and T_{SubframeRxi} is the time when the UE receives the corresponding start of one subframe from positioning node i that is closest in time to the subframe received from positioning node j. Multiple DL PRS resources can be used to determine the start of one subframe from a positioning node. For frequency range 1, the reference point for the DL RSTD is the antenna connector of the UE. For frequency range 2, the reference point for the DL RSTD is the antenna of the UE. The DL RSTD is applicable for RRC_CONNECTED intra-frequency and RRC_CONNECTED inter-frequency.

The UE receive-transmit (Rx-Tx) time difference is defined as T_{UE-RX}−T_{UE-TX}, where T_{UE-RX} is the UE received timing of downlink subframe #i from a positioning node, defined by the first detected path in time, and T_{UE-TX} is the UE transmit timing of uplink subframe #j that is closest in time to the subframe #i received from the positioning node. Multiple DL PRS resources can be used to determine the start of one subframe of the first arrival path of the positioning node. For frequency range 1, the reference point for T_{UE-RX} measurement shall be the Rx antenna connector of the UE and the reference point for T_{UE-TX} measurement shall be the Tx antenna connector of the UE. For frequency range 2, the reference point for T_{UE-RX} measurement shall be the Rx antenna of the UE and the reference point for T_{UE-TX} measurement shall be the Tx antenna of the UE. The UE Rx-Tx time difference is applicable for RRC_CONNECTED intra-frequency and RRC_CONNECTED inter-frequency.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP is the antenna connector of the UE. For frequency range 2, DL PRS-RSRPP is measured based on the combined signal from antenna elements corresponding to a given receiver branch. DL PRS-RSRPP is applicable for RRC_CONNECTED and RRC_INACTIVE.

TABLE T4
Downlink measurements for downlink-based positioning techniques.
DL PRS reference signal received power (DL PRS-RSRP)

| | |
|---|---|
| Definition | DL PRS-RSRP, is the linear average over the power contributions (in ┌W┐) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay |
| | of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED |
| | RRC_INACTIVE |

In aspects of this disclosure, NR carrier phase positioning performance is taken into consideration, and evaluated at least with the carrier phase measurements of a single measurement instance being considered. In aspects of this disclosure, the impact of integer ambiguity on NR carrier phase positioning and potential solutions to resolve the integer ambiguity is taken into consideration.

In aspects of this disclosure, the study of the accuracy improvement based on NR carrier phase measurements is taken into consideration, and in one or more implementations: UE-based and UE-assisted carrier phase positioning; uplink carrier phase positioning and downlink carrier phase positioning; NR carrier phase positioning with the carrier phase measurements of one carrier frequency or multiple frequencies; a combination of NR carrier phase positioning with another standardized Rel. 17 positioning method (e.g., DL-TDOA, UL-TDOA, Multi-RTT, etc.). It should be noted that the use of “carrier phase positioning” does not necessarily mean it is a standalone positioning method.

In aspects of this disclosure, the impact of multipath for the carrier phase positioning is taken into consideration. In aspects of this disclosure, methods of mitigating the impact of multipath for the carrier phase positioning is taken into consideration. In aspects of this disclosure, reuse of the simulation assumptions of NR Rel-16/17 for carrier phase positioning is taken into consideration. Alternatively, or in addition, optional modification of the simulation assumptions defined in NR Rel-16/17 if needed are considered.

In aspects of this disclosure, baseline and optional evaluation scenarios are taken into consideration. In one or more implementations, the baseline evaluation scenario may include at least one of InF-SH and InF-DH. By way of example, the optional evaluation scenario may include at least one of IOO, Umi, and Highway. It should be noted that other evaluation scenarios are not precluded, and that existing Rel-17 downlink and uplink reference signals in Uu interface can be used for the Highway scenario. For the baseline evaluation scenario, the frequency range may be FR1, and for the optional evaluation scenario the frequency range may be FR2.

In one or more implementations (e.g., in addition to the evaluation assumptions of NR Rel-16/17), at least one of the following error sources may also be considered: phase noise (e.g., in FR2), carrier frequency offset (CFO)/Doppler, oscillator-drift, transmitter/receiver antenna reference point location errors, transmitter/receiver initial phase error, and phase center offset. It should be noted that other error sources are not precluded. Additionally or alternatively, UE mobility can be considered. Additionally or alternatively, one or more error sources can be evaluated jointly. Additionally or alternatively, error sources models are provided with their evaluations.

In one or more implementations, other aspects are considered. For NR downlink and/or uplink carrier phase positioning, the carrier phase (CP) at an RF frequency at a receiver is a phase that is a function of the signal propagation time from a Tx antenna reference point of a transmitter (e.g., a TRP or a UE) to an Rx antenna reference point of the receiver (e.g., a UE or a TRP). The propagation time can be expressed in a fractional part of a cycle of the RF frequency and a number of integer cycles, but the CP may be independent of the number of integer cycles.

In aspects of this disclosure, the use of PRUs to facilitate NR carrier phase positioning is taken into consideration. In aspects of this disclosure, the existing DL PRS and UL SRS for positioning can be re-used as the reference signals to enable positioning based on NR carrier phase measurements for both UE-based and UE-assisted positioning. In one or more implementations, enhancements of the existing DL PRS and UL SRS for better positioning performance is considered. In other aspects of this disclosure, for UE-assisted or UE-based NR carrier phase positioning, at least one of the following options is considered: the difference between the carrier phase measured from the DL PRS signal(s) of the target TRP and the carrier phase measured from the DL PRS signal(s) of the reference TRP, and the carrier phase measured from the DL PRS signal(s) of a TRP.

In aspects of this disclosure, the benefits of using the carrier phase measurements of multiple downlink positioning frequency layers for NR carrier phase positioning, which may include the impact of the time gap between the carrier phase measurements of multiple downlink positioning frequency layers (PFLs), is taken into consideration. The initial phase error and the frequency error for each PFLs can be modelled independently. The PRS signals of all PFLs of a TRP can be assumed to be transmitted from the same antenna reference point (ARP) or from different ARPs of the TRP. The location error for ARPs can be modelled independently. The timing errors of the PFLs may not be the same for PFLs in different bands or frequency ranges. In one or more implementations, simultaneous reception of DL PRS from multiple frequency layers is not being supported in Rel-17, which is also taken into consideration.

In aspects of this disclosure, for uplink UE-assisted NR carrier phase positioning, the carrier phase measured from the UL SRS is taken into consideration for positioning purposes. The use of multiple-input multiple-output (MIMO) SRS for positioning purposes may be transparent to a UE. In aspects of this disclosure, the impact of multipath and/or non-line-of-sight (NLOS) on NR carrier phase positioning is taken into consideration. Additionally or alternatively, multipath/NLOS deteriorating the performance of carrier phase positioning and multipath mitigation for NR carrier phase positioning is considered. In aspects of this disclosure, and regarding error modelling, the initial phases of a transmitter for different carriers can be assumed to be independent of each other is taken into consideration. Similarly, the initial phases of a receiver for different carriers can be assumed to be independent of each other is considered.

In aspects of this disclosure, the effectiveness of the following multipath mitigation methods for the carrier phase positioning and the potential on the standard work is taken into consideration. For example, identifying and separating the first path and other paths may be considered. By way of another example, reporting of the carrier phase of the first path, and optionally, the additional paths may be considered. By way of another example, the use of line-of-sight (LOS) and/or NLOS indication for the carrier phase measurements may be considered (e.g., Rel-17 LOS/NLOS indicator can be considered as a starting point). By way of another example, the report of other channel information, such as RSRP/RSRPP, is considered.

In one or more implementations, at least one of the following approaches for NR carrier phase positioning, and identify the potential impact on the standard are considered, such as the reporting of the carrier phase measurements together with the existing positioning measurements, and the reporting of the carrier phase-based measurements alone without reporting the existing positioning measurements.

In aspects of this disclosure and in one or more implementations, terminologies are described and utilized herein. An initiator device initiates a sidelink positioning and/or ranging session, and may be a network entity (e.g., gNB, LMF) or a UE/roadside unit (RSU). A responder device responds to a sidelink positioning and/or ranging session from an initiator device, and may be a network entity, (e.g., gNB, LMF) or UE/RSU. A target-UE (or target UE) may be referred to as a UE of interest whose position (absolute or relative) is to be obtained by the network or by the UE itself (e.g., using sidelink (a PC5 interface)). Sidelink positioning refers to positioning a UE using reference signals transmitted over sidelink (e.g., PC5 interface) to obtain absolute position, relative position, or ranging information. Ranging refers to a determination of the distance and/or the direction between a UE and another entity (e.g., an anchor UE). An anchor UE refers to a UE supporting positioning of a target UE (e.g., by transmitting and/or receiving reference signals for positioning, providing positioning-related information, etc.) over the sidelink interface. The anchor UE may also be referred to as a reference UE or sidelink reference UE.

Further, an assistant UE refers to a UE supporting ranging and sidelink between a sidelink reference UE and a target-UE over sidelink (e.g., PC5 interface), when the direct ranging and/or sidelink positioning between the sidelink reference UE, anchor-UE, and the target-UE cannot be supported. The measurement and/or results of the ranging and/or sidelink positioning between the assistance UE and the sidelink reference UE and that between the assistance UE and the target-UE are determined and used to derive the ranging and/or sidelink positioning results between the target-UE and sidelink reference UE. A sidelink positioning server UE refers to a UE offering location calculation for sidelink positioning and ranging based service. The sidelink positioning server UE interacts with other UEs over sidelink (e.g., a PC5 interface) as necessary in order to calculate the location of the target UE. The target UE or sidelink reference UE can act as a sidelink positioning server UE if location calculation is supported.

Further, a sidelink positioning client UE refers to a third-party UE, other than sidelink reference UE and target UE, which initiates ranging/sidelink positioning service request on behalf of the application residing on it. The sidelink positioning client UE does not have to support ranging and/or sidelink positioning capability, but a communication between the sidelink positioning client UE and sidelink reference UE and target-UE is established (e.g., via PC5 or 5GC) for the transmission of the service request and the result. A sidelink positioning node may refer to a network entity and/or device or UE participating in a sidelink positioning session (e.g., LMF (location server), gNB, UE, RSU, anchor UE, initiator and/or responder UE). A configuration entity refers to a node network node or device or UE capable of configuring time-frequency resources and related sidelink positioning configurations. A sidelink positioning server UE may serve as a configuration entity. A configuration entity refers to a network node or device (e.g., a UE) capable of configuring time-frequency resources and related sidelink positioning configurations. A sidelink positioning server UE may serve as a configuration entity.

In aspects of carrier phase positioning configuration, solutions enable configurations for carrier phase positioning. Implementations include carrier phase measurement configuration, on-demand PRS configurations for carrier phase measurements, downlink carrier phase measurements with other downlink signals and channels, and enabling joint downlink and sidelink carrier phase measurements.

Aspects of the present disclosure include solutions for enabling configurations related to carrier phase positioning, such as to configure one or more responder and/or target UE devices to perform standalone carrier phase measurements or joint carrier phase measurements with other positioning measurements over Uu or sidelink (PC5) interfaces based on a received PRS configuration. Aspects support on-demand PRS for downlink-based carrier phase measurements in order to update the PRS configuration related downlink-based carrier phase measurements for both UE-initiated and LMF-initiated on-demand PRS requests. Aspects also support accurate downlink-based carrier phase configurations in the presence of other downlink signals and channels without the aid of a measurement gap. This also supports minimizing the time gap between performing downlink and sidelink carrier phase measurements via an appropriate time-based configuration.

Any of the described implementations can be implemented in combination with each other to support NR RAT-dependent positioning methods over the Uu (uplink and downlink) and sidelink (PC5) interface. For the purposes of this disclosure, a positioning-related reference signal may be referred to as a reference signal used for positioning procedures and/or purposes in order to estimate a target-UE's location (e.g., PRS, or based on existing reference signals, such as channel state information reference signal (CSI-RS) or SRS, SRS for positioning, MIMO SRS). A target-UE may be referred to as the device or network entity to be localized and/or positioned, and in various implementations, the term ‘PRS’ can refer to any signal such as a reference signal, which may or may not be used primarily for positioning. Additionally, any reference made to position and/or location information can refer to either an absolute position, relative position with respect to another node or network entity, ranging in terms of distance, ranging in terms of direction, or any combination thereof.

With reference to one or more implementations of carrier phase measurement configuration, a configuration entity, such as location server (LMF), anchor UE, RSU, sidelink positioning server UE, or UE, may configure one or more responder devices (e.g., receivers or a target-UE) to perform carrier phase measurements in a standalone manner or in a joint manner with other Uu and/or sidelink positioning measurements, such as TDoA, RTT type methods including single-sided, double-sided, or multi-device (cell) RTT, AoA, AoD, radio resource management (RRM) measurements such as CSI-RS, synchronization signal block (SSB)-RS, or a combination thereof. In an implementation, a determination to utilize standalone carrier phase measurement or joint carrier phase measurements in conjunction with other positioning techniques can be made by the configuration entity depending on the scenario governed by the following basic equation (1), which defines the carrier phase as a function of range or distance between a single transmitter and receiver pair:

$${β}_{a} = 2 π ( \frac{{f}_{a} d}{c} - {N}_{a} ) + \frac{2 π}{{f}_{a}} {δ}_{a} + {θ}_{a} + {ϵ}_{a} , a = 1 , 2 , … , A \qquad ( 1 )$$

where β refers to the carrier phase measurement at the a^{th} frequency, fa is the carrier frequency or subcarrier frequency of the PRS, c is the speed of light, d is the relative distance between the transmitter (e.g., anchor node) and receiver (e.g., target node), δₐ is the oscillator drift between the clocks of the transmitter and receiver (clock frequency biases), θₐ is the initial phase offset error difference between the transmitter and receiver, and ϵₐ is the carrier phase measurement error, which can be present at the transmitter and receiver.

The integer ambiguity can be configured with an associated confidence, quality, and/or uncertainty metric indicating the confidence of the integer ambiguity estimation range. If the integer ambiguity at a particular frequency is observed to be above a certain threshold (e.g., >95% or 99%), this implies that the integer ambiguity is estimated with a high degree of confidence according to the radio channel scenario, then the standalone carrier phase measurement may be configured to determine (e.g., the relative distance (ranging for distance)) between two UEs. If the confidence of the integer ambiguity measurements is found to be below the defined or configured confidence interval, this implies that the integer ambiguity may be uncertain, and therefore it would be more appropriate to combine the carrier phase measurement with positioning measurements that are based on time (e.g., ToA, RSTD, or UE Rx-Tx time difference, or gNB Rx-Tx time difference measurements) or angle (e.g., AoA or AoD measurements). An example implementation of this can be considered as a two-shot positioning estimation technique, where for the first shot, the distance of the target-UE with respect to a transmitter (e.g., a gNB or anchor-UE) is determined with a timing (e.g., RSTD, RTT) or angular (AoA, AoD) measurement providing an unambiguous distance of X meters. Thereafter, the integer ambiguity is resolved within the X meters, and carrier phase is employed for the second shot to estimate the finer granular distance (e.g., cm-level accuracy)<X m with a reduced integer ambiguity search space <X m.

In another implementation, the integer ambiguity and associated quality metric may be derived based on the approximate location of the target-UE. The approximate location can be derived using RSRP, reference signal received quality (RSRQ), and/or received signal strength indication (RSSI) measurements based on PRS, CSI-RS, SSB, physical sidelink shared channel (PSSCH), physical sidelink control channel (PSCCH), and so forth to determine the approximate location of the UE (e.g., relative distance between the transmitter (e.g., gNB, anchor UE) and receiver (e.g., target-UE)). In an alternative implementation, the ToA, RSTD, UE Rx-Tx, or gNB Rx-Tx time difference measurement can be used to obtain a coarser accuracy initial location estimate to assist in bounding the integer ambiguity to a narrower search space. Positioning techniques such as NR E-CID may also be employed to determine this approximate initial location.

An equation (2) transforms from equation (1) in the context of Na (integer cycles):

$${N}_{a} = \frac{{f}_{a} d}{c} - \frac{{β}_{a} {f}_{a}}{2 π} - \frac{1}{{f}_{a}} - {f}_{a} {θ}_{a} - {f}_{a} {ϵ}_{a} \qquad ( 2 )$$

where the d is obtained from the approximate location methods as described above, to find a converging solution to mitigate the integer ambiguity issue.

An equation (3) extends equation (1) among different transmitter-receiver pairs, and the following is derived:

$${β}_{i , a} = 2 π ( \frac{{f}_{i , a} {d}_{i}}{c} - {N}_{i , a} ) + \frac{2 π}{{f}_{i , a}} {δ}_{i , a} + {θ}_{i , a} + {ϵ}_{i , a} , \qquad ( 3 )$$

$$a = 1 , 2 , … , A ; i = 1 , 2 , 3 … M$$

where a carrier phase measurement is performed based on every i^{th} transmitting node up to a total of M nodes (e.g., gNB, anchor UE, and so forth) for the same receiver, where multiple di with respect to each transmitting node may be derived and thereafter the relative location and absolute location information (depending on how many transmitting nodes are involved) may be computed. The decision on whether to perform standalone carrier phase measurements may also depend on the integer cycles and associated integer ambiguity information and quality metrics across each a^{th} frequency at each i^{th} node. The configuration entity can evaluate the integer ambiguity confidence across all frequencies and all nodes to reach such a decision (e.g., using averaging across all frequencies).

In an extended implementation, the equation (1) and equation (3) are governed by the measured first arrival path, which may be considered to be LOS. Multipath and NLOS effects of the received signal can lead to inaccurate carrier phase measurements and may require further compensation during the reporting procedure. In implementations, the downlink or one directional carrier phase measurements can be performed per positioning frequency layer associated with various PRS parameters. A subcarrier spacing (based on PRS) defines the subcarrier spacing of the downlink-PRS resource (e.g., 15, 30, 60 kHz for FR1; 60, 120 kHz, 240 kHz, 480 kHz, 960 kHz for FR2). All of the downlink-PRS resources and downlink-PRS resource sets in the same positioning frequency layer have the same value. A resource bandwidth defines the number of physical resource blocks (PRBs) allocated for the downlink or sidelink PRS resource (allocated downlink or sidelink PRS bandwidth) in multiples of X PRBs, where X can be configured. All of the PRS resources of a PRS resource set within a same resource pool have the same bandwidth. All PRS resource sets belonging to the same positioning frequency layer have the same value of PRS bandwidth and start PRB. The start PRB defines the start PRB index defined as an offset with respect to reference PRS point A for the positioning frequency layer. The PRS point A defines the absolute frequency of the reference resource block for the PRS, and its lowest subcarrier is also known as DL-PRS point A. The PRS comb size N defines the RE spacing in each symbol of a PRS resource, and all PRS resource sets belonging to the same positioning frequency layer or resource pool have the same value of comb size N. The PRS cyclic prefix defines the cyclic prefix (CP) length of the PRS resource, and all PRS resources sets belonging to the same positioning frequency layer have the same CP.

In an extended implementation, the above PRS parameters may also apply to carrier phase measurements performed on the uplink by the gNB using (e.g., SRS for positioning, MIMO SRS or bi-directional carrier phase measurements along the sidelink by the initiator, or transmitting UE) or on the Uu interface (downlink carrier phase measurements and then uplink carrier phase measurements or vice versa). In implementations, a configuration entity can configure the responder and/or receiver device to perform carrier phase measurements based on a particular PRS configuration (e.g., which may apply to sidelink or uplink and downlink signals, which includes the following parameters: a number of PRS symbols, a PRS RE offset, a comb size, a PRS periodicity, a PRS muting pattern, PRS repetitions, carrier information (including carrier frequency, subcarrier spacing, frequency range (e.g., FR1, FR2, propagation delay)), and a number of measurement samples or measurement instances (e.g., 1, 2, 3, 4, and so forth). Other related assistance information configuration parameters, corresponding to the above PRS configuration, includes estimated integer cycles derived based on internal estimation at the configuration entity, received assistance information from nearby PRUs, and/or anchor UEs (e.g., within 1-5 m range); an integer ambiguity value range bound by a minimum and maximum value; and/or an integer ambiguity confidence and/or quality indicator.

The carrier phase measurements are associated to measurements performed on PRS time-frequency resources that may span one or more carriers, one or more BWPs, one or more resource pools within a BWP, or combination thereof. These may be associated with carriers, BWPs, on the uplink, downlink, or sidelink, while the resource pools are associated with sidelink PRS signals. The configuration entity can further signal the required PRS assistance data configuration parameters as described above to perform carrier phase measurements on the uplink, downlink, and/or sidelink.

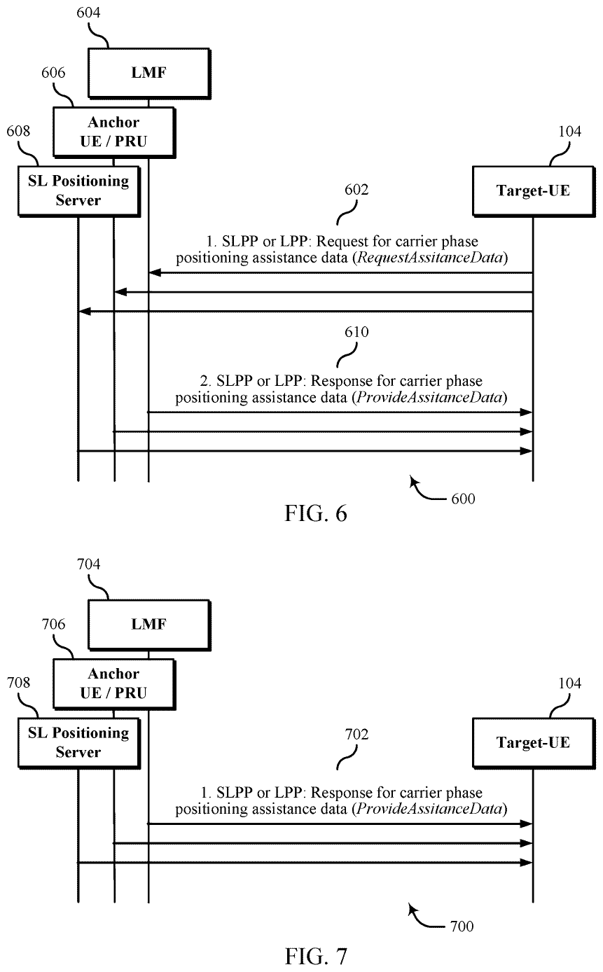

FIG. 6 illustrates an example 600 of one or more procedures for UE-based carrier phase positioning configuration, which supports carrier phase positioning configuration in accordance with aspects of the present disclosure. This example 600 illustrates the high-level signaling to enable carrier phase positioning using solicited signaling for UE-based carrier phase positioning. A target-UE 104 transmits a request 602 to a network entity (e.g., any one of a LMF 604, an anchor UE 606 (or PRU), and/or a sidelink positioning server UE 608). The request 602 to the anchor UE 606 (or PRU), sidelink positioning server UE 608, or LMF 604 requests one or more sets of a PRS configuration and/or assistance data to perform carrier phase measurements. Depending on the involved network nodes or network entities, the request 602 signaling for PRS configuration may be carried using LTE positioning protocol (LPP), or sidelink positioning protocol (SLPP), or any defined positioning protocol over sidelink. This is mainly applicable to a UE-based type positioning method, where the target-UE will compute the absolute and/or relative location information based on the performed carrier phase measurements at the UE-side.

Any one of the network entities (e.g., the LMF 604, the anchor UE 606 (or PRU), and/or the sidelink positioning server UE 608) can respond to the request 602 with a response 610 to the target-UE with the provided PRS configuration and/or assistance data required to perform the carrier phase measurements. Depending on the involved nodes and/or network entities, the request signaling for PRS configuration may be carried using LPP, or SLPP, or any defined positioning protocol over sidelink. This is applicable to a UE-based type positioning method, where the target-UE will compute the absolute and/or relative location information based on the performed carrier phase measurements at the UE-side and the UE-assisted type position method where either the LMF, Anchor UE (or PRU), or sidelink positioning server UE will compute the absolute and/or relative location information based on the performed carrier phase measurements. The response may be signaled using positioning system information broadcast signaling (posSIB), sidelink broadcast, groupcast or unicast signaling, UE-specific LPP signaling, and/or a combination thereof.

FIG. 7 illustrates an example 700 of one or more procedures for UE-based carrier phase positioning configuration, which supports carrier phase positioning configuration in accordance with aspects of the present disclosure. This example 700 illustrates unsolicited signaling to enable UE-assisted carrier phase positioning. Similar to the solicited response 610 (shown in example 600), an unsolicited response 702 to the target-UE 104 from a network entity (e.g., a LMF 704, an anchor UE 706 (or PRU), and/or a sidelink positioning server UE 708) transmits the response 702 with the provided PRS configuration and/or assistance data required to perform the carrier phase measurements. Depending on the involved nodes and/or network entities, the request signaling for PRS configuration may be carried using LPP, or SLPP, or any defined positioning protocol over sidelink. This is applicable to a UE-based type positioning method, where the target-UE will compute the absolute and/or relative location information based on the performed carrier phase measurements at the UE-side and the UE-assisted type position method where either the LMF, Anchor UE (or PRU), or sidelink positioning server UE will compute the absolute and/or relative location information based on the performed carrier phase measurements. The response may be signaled using positioning system information broadcast signaling (posSIB), sidelink broadcast, groupcast or unicast signaling, UE-specific LPP signaling, and/or a combination thereof.

In other implementations, bi-directional carrier phase measurements can be enabled by performing carrier phase measurements at the transmitter and receiver side. For example, in the case of sidelink (PC5), where the responder UE performs the first set of carrier phase measurements with a defined integer number of cycles and associated ambiguity range, and thereafter the initiator UE performs a second set of carrier phase measurements with the same defined set of integer number of cycles and ambiguity used to derive the first set of carrier phase measurements, provided that the same carrier frequency and signal numerology are used to transmit both PRS signals. Both carrier phase measurements can be jointly processed to derive the relative location or distance between the two nodes or network entities.

In another example, bi-directional carrier phase measurements may first be performed on the downlink (e.g., using downlink carrier phase measurements) and then on the uplink (e.g., using uplink carrier phase measurements), or vice-versa. These bi-directional carrier phase measurements can be performed by recording the time stamps and associated quality metrics for each carrier phase measurement. The time gap between uplink and downlink carrier phase positioning measurements should be small enough in order to utilize it for location estimation, where a threshold time may be configured such that the gap between the uplink carrier phase and the downlink carrier phase measurements are not outdated. In addition, the clock drifts of the transmitter and receiver may be exchanged in order to compensate for DL or UL carrier phase measurements. In another implementation, the effects due to time and doppler, UE absolute or relative velocity may also be further considered when performing the bi-directional carrier phase measurement. For example, the UE mobility and carrier phase measurement performed in one direction may be different to the carrier phase measurement performed in the reverse direction, depending on the UE velocity and location. Such compensation parameter(s) may also need to be configured and signaled (e.g., UE location change, velocity change, time stamp information, LOS/NLOS change, doppler parameters (e.g., doppler shift)).

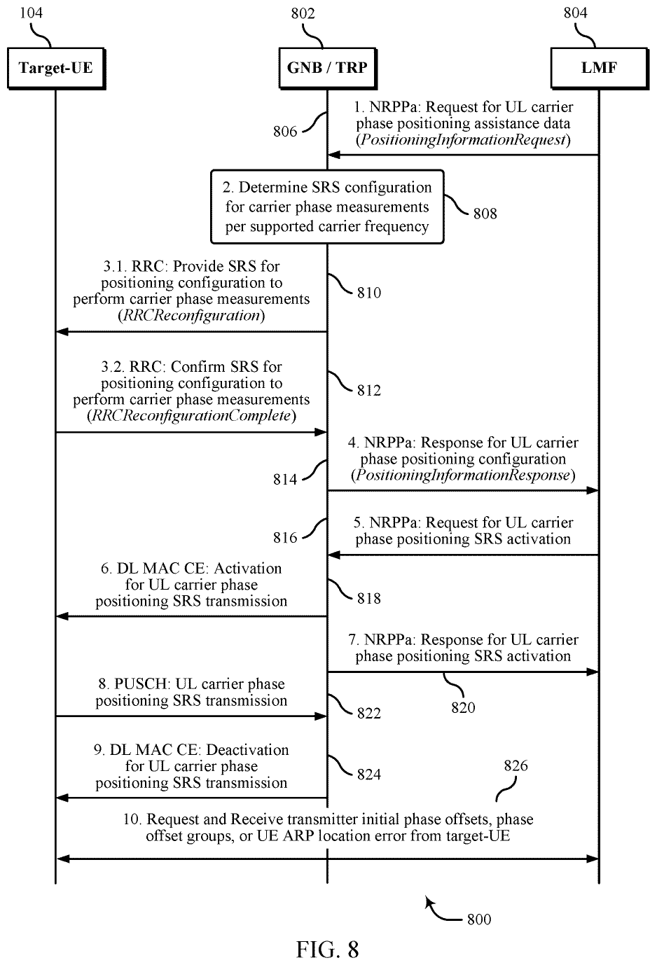

FIG. 8 illustrates an example 800 of a procedure for NG-RAN assisted carrier phase positioning configuration, which supports carrier phase positioning configuration in accordance with aspects of the present disclosure. This example 800 illustrates signaling to enable NG-RAN assisted carrier phase positioning, involving a target-UE 104, a gNB 802 (or TRP), and an LMF 804.

At 806, the LMF 804 requests one or more gNBs 802 (or TRPs) for one or more sets of SRS for positioning configurations to be provided to the target-UE in order to perform uplink carrier phase measurements at the gNB-side. At 808, one or more gNBs 802 (or TRPs) determine the SRS configuration per target-UE, which may be configured per carrier. In another implementation, the SRS configurations may be broadcasted to multiple UEs for use in multiple cells or within a predefined positioning system information area, or an area with an associated validity in terms of time or area, or a combination thereof.

The gNB 802 configures the target-UE 104 to perform SRS for positioning transmissions via RRC signaling using (e.g., RRCConfiguration message). At 810, the gNB 802 configures the target-UE 104 to perform SRS for positioning transmissions in order to perform standalone or joint uplink carrier phase measurements with other timing or angle-based measurements. At 812, the target-UE 104 confirms reception of the one or more SRS for positioning configuration to perform standalone or joint uplink carrier phase measurements with other timing or angle-based measurements.

At 814, the gNB 802 (or TRP) responds to the LMF 804 with the successful or unsuccessful configuration of the target-UE to perform SRS transmissions for the uplink carrier phase measurements. At 816, the LMF 804 requests the one or more gNBs 802 (or TRPs) to activate the one or more SRS for positioning configurations for transmission by the target-UE. At 818, the gNB 802 activates the transmission of SRS to the target-UE 104 by transmitting a downlink medium access control element (MAC CE) activation command to the target-UE. At 820, the gNB 802 (or TRP) responds to the LMF 804 with the successful or unsuccessful activation of the target-UE to perform SRS transmissions for the uplink carrier phase measurements. At 822, the target-UE 104 transmits SRS for positioning in RRC_CONNECTED or RRC_INACTIVE state using the small data transmission framework using a dynamic grant or configured grant. Further, at 824, the gNB 802 may deactivate the transmission of SRS related to the uplink carrier phase positioning upon successful completion of the SRS transmission by the target-UE. In another implementation, the SRS for positioning configuration may be pre-configured and may be considered valid for multiple areas, cells, tracking areas, or combinations thereof. The SRS configuration parameters may include timing alignment parameters (e.g., valid timing advances across different cells including current and previous serving cells, valid spatial relation including RS and pathloss parameters which may be maintained across different cells, or a combination thereof).

Additionally, at 826, the location server (e.g., the LMF 804, or a configuration entity) may request and receive a response of the transmitter initial phase offsets from the target-UE, such as a group of transmitter (UE) initial phases offsets, UE ARP (antenna reference point) errors, or a combination thereof using LPP for uplink carrier phase measurements, or using SLPP in the case of sidelink carrier phase measurements. The error offsets can be transmitted based on a certain error margin, especially in the case of the phase error offset group across a number of Tx beams and SRS resources from the UE-side. Furthermore, each of the error offsets may be associated with an identifier to unambiguously associate each of the UE transmitter errors. In another implementation, the serving gNB may receive such error information via UL RRC messages and thereafter forward these messages to the LMF via suitable request and response NRPPa messages.

According to another implementation, the target-UE can be configured to measure the phase statistics (e.g., mean, variance, standard deviation) across all subcarriers in order to derive the overall carrier phase measurement. In another implementation, linear fitting can be utilized to derive the phase slope across all subcarriers. This is in addition to the overall carrier phase measurement performed per carrier frequency or per PFL since it also considers the average (mean) phase of all the subcarriers transmitted within a carrier. The phase values may be averaged out over k subcarriers to obtain the overall phase estimate. Using the overall carrier frequency (as well as individual k subcarriers or subcarrier phase difference between receiver and transmitter) both sets of frequencies may be used to perform the carrier phase measurement.

In another implementation, the configuration entity may signal the potential error types to the network entity or network node performing the carrier phase measurement as part of the carrier phase configuration in the assistance data. This depends on the knowledge and accuracy of the error types as known by the configuration entity. This may include impairments such as: initial transmitter phase offset, or a group of phase offset if the offset is not widely varying within a certain margin. The group transmitter phase offset may be associated with an ID; the transmitter antenna reference point location error may be associated with an ARP error ID; known initial receiver phase offset, or a group of phase offset if the offset is not widely varying within a certain margin. The group receiver phase offset may be associated with an ID; a receiver antenna reference point location error; known carrier frequency offset (from a target-UE); known antenna phase center offset (from the target-UE); known oscillator drift (from the target-UE); and/or a combination thereof.

With reference to on-demand PRS configuration for carrier phase measurements, the LMF-initiated on-demand PRS can be performed with the NR-RAN (e.g., gNB) to update the PRS configuration related to the carrier phase measurements. The carrier phase measurements are highly sensitive to the radio channel environment (e.g., multipath, NLOS, phase offsets, etc.) and therefore, the carrier phase measurements are best performed on updated PRS configurations that reflect the real-time radio channel conditions. The LMF-initiated on-demand PRS comprises a request to the gNB or TRP from the LMF, and a corresponding response message to the LMF from the gNB or TRP. The request can include an explicit list of PRS parameters related to the carrier phase positioning configuration in which to update and/or TRPs in which to switch on or off PRS transmission for the purposes of downlink, uplink, or sidelink carrier phase measurements.

The request can include a pre-defined list of parameters or index of PRS and/or SRS configurations from which to update the existing or preconfigured DL-PRS, SRS, or SL-PRS configuration for performing downlink, uplink, or sidelink carrier phase measurements. The index can include one or more the below PRS parameters, and the on-demand PRS parameters, as well as additional assistance information, can include a carrier frequency, subcarrier spacing, comb size N, a frequency range (e.g., FR1 or FR2), PRS periodicity, a resource repetition factor, quasi co-location (QCL) information, and/or resource bandwidth. Other related assistance information configuration parameters, which can be updated using the on-demand PRS functionality based on the above PRS configuration parameters include integer cycles, integer ambiguity, transmitted (e.g., gNB) initial phase offset errors, and/or gNB antenna reference location errors.

The response message from the gNB may include any one or more combination of the above-described parameters. The response message may also include an unavailability of on-demand PRS configurations related to carrier phase measurements in the event that the requested parameters cannot be updated or provided. The NRPPa interface may be utilized to perform the exchange of such parameters between LMF and NRPPa (e.g., TRP Information Request and TRP Information Response).

According to another aspect, the UE-initiated on-demand PRS can be performed to update the PRS configuration related to the carrier phase measurements. The UE-initiated on-demand PRS includes a request to the LMF and a response message from the LMF, where the request can include an explicit list of PRS parameters in which to update for the purposes of performing downlink carrier phase measurements, and/or a pre-defined list of parameters or index of PRS configurations from which to update the existing or preconfigured PRS configuration for performing downlink carrier phase measurements. The on-demand PRS parameters include carrier frequency, subcarrier spacing, a comb size N, a frequency range (e.g., FR1 or FR2), a PRS periodicity, a resource repetition factor, QCL information, and/or resource bandwidth. Other related assistance information configuration parameters, which can be updated using the UE-initiated on-demand PRS functionality based on the above PRS configuration parameters include integer cycles, integer ambiguity, transmitted (e.g., gNB) initial phase offset errors, and/or gNB antenna reference location errors.

The response message from the LMF can include any one or combination of the above-described parameters. The response message may also include an unavailability of on-demand PRS configurations in the event that the requested parameters cannot be updated or provided. The LPP interface may be utilized to request and perform the exchange of such parameters.

According to another aspect, the UE-initiated on-demand PRS can may be performed to update the PRS configuration related to the sidelink (PC5) carrier phase measurements. The UE-initiated on-demand PRS includes a request to the configuration entity (e.g., sidelink positioning server UE, anchor UE, and a response message from the LMF), where the request can include an explicit list of PRS parameters in which to update for the purposes of performing downlink carrier phase measurements, and/or a pre-defined list of parameters or index of PRS configurations from which to update the existing or preconfigured PRS configuration for performing downlink carrier phase measurements. The on-demand PRS parameters include a carrier frequency, subcarrier spacing, a comb size N, a frequency range (e.g., FR1 or FR2), a PRS periodicity, a resource repetition factor, QCL information, and/or resource bandwidth. Other related assistance information configuration parameters, which can be updated using the SL UE-initiated on-demand PRS functionality based on the above PRS configuration parameters include integer cycles, integer ambiguity, transmitted (e.g., gNB) initial phase offset errors, and/or gNB antenna reference location errors.

The response message from the LMF may include any one or more combination of the above-described parameters. The response message may also include an unavailability of on-demand PRS configurations in the event that the requested parameters cannot be updated or provided. The SLPP or a newly defined positioning protocol along the sidelink may be utilized to request and perform the exchange of the parameters.

With reference to downlink carrier phase measurements with other downlink signals and channels, a method avoids significant degradation of the downlink carrier phase measurements in the presence of other downlink signals and channels. The downlink carrier phase measurements and processing are performed without a measurement gap and are therefore susceptible to noise and/or interference impairments as a result of shared normal communication transmission procedures.

In an implementation, subject to a UE's capability, a dedicated prioritization of carrier phase measurements based on a set of PRS resources is configured by the network or configuration entity. If the downlink PRS to be measured for carrier phase measurements according to a configured PFL within an active downlink BWP and has the same numerology as the downlink BWP, then the downlink PRS for performing carrier phase measurements can be prioritized with respect to other downlink signals and channels. This prioritization can be (pre-) configured in terms of a time window, time duration, or timer received from the higher-layers within which PRS resources related to carrier phase measurements are to be prioritized over the other downlink signals and channels. In this implementation, the other configured downlink signals and channels, physical downlink control channel (PDCCH), physical downlink shared channel (PDSCH), CSI-RS, etc. do not need to be received or measured. The configuration entity can be a LMF, a gNB, a RSU, an anchor UE, a sidelink positioning server UE, a target-UE, or any combination thereof with respect to existing data, channels, and signals as further described. In an example implementation, the prioritization window can be configured to measure the phase or average phase of a group of subcarriers, with specific identifiers (e.g., subcarrier grouping IDs). In another implementation, knowledge of the subcarrier grouping IDs is sufficient to perform the carrier phase measurements.

Furthermore, the target-UE may not be expected to measure the DL PRS outside or without the measurement gap if the expected received timing difference, integer ambiguity, carrier phase between the DL PRS from the non-serving cell, and that from the serving cell, determined by the higher layer parameters nr-DL-PRS-ExpectedRSTD, nr-DL-PRS-ExpectedRSTD-Uncertainty, is larger than maximum Rx timing difference while any one or more potential parameters DL-IntegerCycles, DL-IntegerAmbiguity, DL-IntegerAmbiguityUncertainty, DL-CarrierPhase, DL-Carrierphase Uncertainty exceeds a pre-defined threshold according to its parameter range provided by its UE capability. This may occur when the downlink timing measurements (e.g., RSTD, ToA measurements) are coupled with the downlink carrier phase measurements.

In other implementations, priority rules can be configured beforehand in order to map the different states of priority. For example, in a priority state (1) DL PRS for downlink-based carrier phase measurements is a higher priority than all of the downlink signal and channels except SSB. In a priority state (2) DL PRS for downlink-based carrier phase measurements is a lower priority than PDCCH and the PDSCH scheduled by downlink control information (DCI) formats 1_1, 1_2, or combination thereof with the priority indicator field in the corresponding DCI format set to 1, and is a higher priority than other downlink signals and channels except SSB. In a priority state (3) DL PRS for downlink-based carrier phase measurements is lower in priority than all other downlink signals and channels except SSB. In a priority state (4) DL PRS for downlink-based carrier phase measurements is lower in priority than all other downlink signals and channels including SSB.

The number of PFLs to be measured within the prioritization window can be configured (e.g., PFL=1, 2, 3, etc.). The priority may be applicable to overlapping or non-overlapping DL PRS symbols which with respect to other downlink signals and channels, is subject to a UE's capability. In another implementation, different priority states may be defined with respect to PRS utilized for different positioning techniques (e.g., DL-PRS used for performing RSTD measurements has a higher priority than carrier phase measurements and vice-versa). A priority table or index may be mapped based on each positioning technique together with priority states for each positioning technique and can be configured by the network or configuration entity.

In another implementation, the interference caused by the other shared downlink signals and channels can be measured (e.g., using signal to interference and noise ratio (SINR) or other interference measurement metrics) and reported to the configuration entity (e.g., LMF) in order determine any degradation to the DL-PRS for the purposes of downlink carrier phase measurements. The LMF may then request the gNB for better overall resource provisioning (e.g., in terms of orthogonal resource allocation of DL PRS resources with respect to other downlink signals and channels). In an extended implementation, the LMF can also mute or not transmit PRS resources that are found to be overlapping with other downlink signals and channels in coordination with the serving gNB. The interference may also be configured to be measured within a specified window which may or may not overlap with the aforementioned priority window. This window for interference measurement may also be pre-configured to the UE by the network. This window for interference measurement may be subject to a UE's capability. The UE may report the measured interference using (e.g., SLPP or LPP ProvideLocationInformation message), example of interference measurement metrics of the PRS and downlink signals and channels may include SINR, SNR, and so forth.

The described prioritization or interference measurement windows can be configured with a start time, window duration, end time, periodicity (if known), and can be defined with respect to SFN0, or a combination thereof. In another implementation, the timer can be configured with a specific duration, start time, end time, coordinated universal time (UTC), or other well-known time base, or combination thereof. Both the window and timer may also be separately activated or deactivated by the configuration entity using lower layer signaling, or LPP or SLPP signaling (e.g., LMF).

The LPP interface and protocol can be used for this purpose to provide and/or activate the described prioritization window or interference measurement functionality. In other implementations, lower layer signaling between a gNB and UE may also be used (e.g., DCI, DL MAC CE, RRC). The NRPPa interface and messages can be used to exchange messages between a gNB and LMF to enable the above functionality, especially in terms of which other downlink signals and channels are to be scheduled with DL PRS used to perform downlink carrier phase measurements. Furthermore, the joint downlink and sidelink measurement and processing window can be signaled to the target-UE using LPP or SLPP, or a combination thereof using exemplary messages, such as Provide AssistanceData or RequestLocationInformation.

With reference to enabling joint downlink and sidelink carrier phase measurements, a method is described, which allows a target-UE to efficiently perform and process downlink carrier phase measurements and sidelink carrier phase measurements in a manner that does not impact the overall accuracy of jointly processing both measurements for absolute or relative location estimation.

In an implementation, the configuration entity (or entities) may coordinate the carrier phase measurement configuration such that the time gap between performing a downlink carrier phase measurement and sidelink carrier phase measurement is minimized. An example of minimizing the time gap in a configurable manner is via the use of a joint carrier phase measurement window, or in another implementation configuration of a timer in which both downlink carrier phase and sidelink carrier phase measurements are performed within the configured window or before the expiry of the timer. In an implementation, the entities involved with configuring both the downlink and sidelink PRS carrier phase configurations should also be time synchronized (e.g., share a synchronization source).

The described time-based parameters will be aligned such that sufficient time is provided for buffering and processing of DL-PRS and SL-PRS symbols. In an in-coverage or partial coverage scenario, the LMF can configure a joint measurement window for downlink and sidelink carrier phase measurements. In another scenario, two configuration entities, such as an LMF and sidelink positioning server UE or anchor UE, may exchange messages related to the configuration of the joint measurement and processing window for both downlink and sidelink carrier phase measurements. The LPP or SLPP interface and protocol may be used for this purpose. Furthermore, the joint downlink and sidelink measurement and processing window may be signaled to the target-UE using LPP or SLPP, or a combination thereof using exemplary messages, such as Provide AssistanceData or RequestLocationInformation.

The described joint downlink and sidelink carrier phase measurement windows can be configured with a start time, window duration, end time, periodicity (if known), and can be defined with respect to SFN0, or a combination thereof. In another implementation, the timer can be configured with a specific duration, start time, end time, UTC, or other well-known time base, or combination thereof. Both the window and timer may also be separately activated or deactivated by the configuration entity using lower layer signaling, or LPP or SLPP signaling (e.g., LMF).

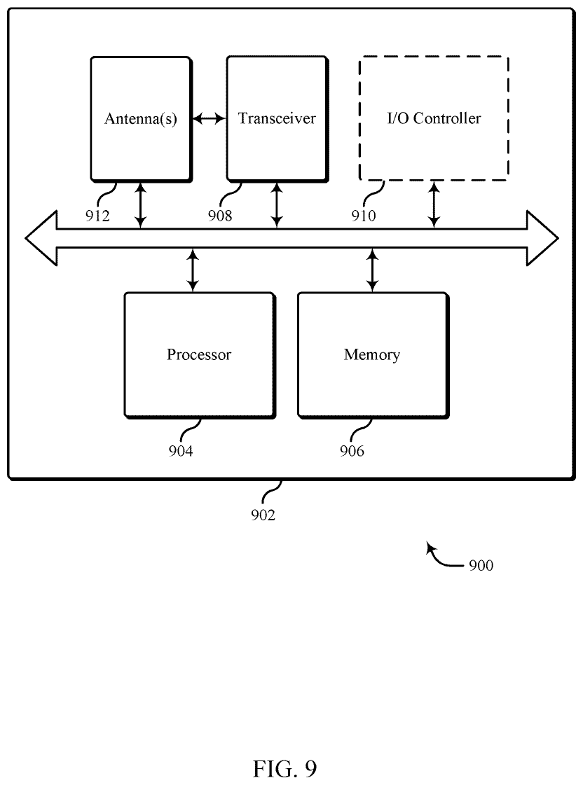

FIG. 9 illustrates an example of a block diagram 900 of a device 902 that supports carrier phase positioning configuration in accordance with aspects of the present disclosure. The device 902 may be an example of a target UE (e.g., a UE 104) as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. The processor 904 may be configured as or otherwise support a means for receiving a first signaling of one or more carrier phase positioning configurations that include at least one of PRS parameters, transmitter error types, an integer ambiguity, or integer ambiguity quality metrics; and receiving a second signaling of one or more PRS transmissions on which carrier phase measurements are performed based at least in part on the one or more carrier phase positioning configurations.

Additionally, the processor 904 may be configured as or otherwise support any one or combination of determining location information of a location of the apparatus based at least in part on the carrier phase measurements. The one or more carrier phase positioning configurations include PRS resources to perform at least one of uplink carrier phase measurements, downlink carrier phase measurements, or sidelink carrier phase measurements according to a measured first arrival path. The PRS parameters include at least one of a number of symbols, a RE offset, a PRS comb size, a periodicity, a muting pattern, repetitions, a subcarrier spacing, an integer ambiguity value range, an integer confidence interval, or carrier information. The carrier phase measurements are associated with measurements performed on PRS time-frequency resources that span at least one of one or more carriers, one or more BWPs, or one or more resource pools within a BWP. Bi-directional carrier phase measurements are based at least in part on the carrier phase measurements performed at a transmitter and a receiver in a single positioning session. The method further comprising determining the carrier phase measurements based at least in part on a carrier frequency, subcarrier spacing, or a propagation delay of a received PRS of the one or more PRS transmissions. The transmitter error types include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. The method further comprising requesting at least one of a downlink carrier phase configuration or a sidelink carrier phase configuration using LMF-initiated or UE-initiated on-demand PRS. The method further comprising receiving a third signaling of a configuration of a dedicated prioritization window of additional carrier phase measurements based on a set of PRS resources associated with one or more downlink signals and channels. The configuration of the dedicated prioritization window of the additional carrier phase measurements is configured by at least one of a network entity or a configuration entity. Different priority states of respective different positioning techniques are defined with respect to a PRS utilized for the different positioning techniques. A downlink-PRS used for performing RSTD measurements has a higher priority state relative to a priority state of the carrier phase measurements. The carrier phase measurements have a higher priority state relative to a priority state of a downlink-PRS used for performing RSTD measurements. The method further comprising measuring signal interference caused by shared downlink signals and channels; and transmitting a third signaling of the measured signal interference to a configuration entity that determines a degradation to a downlink-PRS for downlink carrier phase measurements. For a carrier phase measurement configuration, a time gap between performing a downlink carrier phase measurement and a sidelink carrier phase measurement is minimized by using a joint downlink and sidelink measurement window.

Additionally, or alternatively, the device 902, in accordance with examples as disclosed herein, may include a processor and a memory coupled with the processor, the processor configured to cause the apparatus to: receive a first signaling of one or more carrier phase positioning configurations that include at least one of PRS parameters, transmitter error types, an integer ambiguity, or integer ambiguity quality metrics; and receive a second signaling of one or more PRS transmissions on which carrier phase measurements are performed based at least in part on the one or more carrier phase positioning configurations.

Additionally, the wireless communication at the device 902 may include any one or combination of the processor is configured to cause the apparatus to determine location information of a location of the apparatus based at least in part on the carrier phase measurements. The one or more carrier phase positioning configurations include PRS resources to perform at least one of uplink carrier phase measurements, downlink carrier phase measurements, or sidelink carrier phase measurements according to a measured first arrival path. The PRS parameters include at least one of a number of symbols, a RE offset, a PRS comb size, a periodicity, a muting pattern, repetitions, a subcarrier spacing, an integer ambiguity value range, an integer confidence interval, or carrier information. The carrier phase measurements are associated with measurements performed on PRS time-frequency resources that span at least one of one or more carriers, one or more BWPs, or one or more resource pools within a BWP. Bi-directional carrier phase measurements are based at least in part on the carrier phase measurements performed at a transmitter and a receiver in a single positioning session. The processor is configured to cause the apparatus to determine the carrier phase measurements based at least in part on a carrier frequency, subcarrier spacing, or a propagation delay of a received PRS of the one or more PRS transmissions. The transmitter error types include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. The processor is configured to cause the apparatus to request at least one of a downlink carrier phase configuration or a sidelink carrier phase configuration using LMF-initiated or UE-initiated on-demand PRS. The processor is configured to cause the apparatus to receive a third signaling of a configuration of a dedicated prioritization window of additional carrier phase measurements based on a set of PRS resources associated with one or more downlink signals and channels. The configuration of the dedicated prioritization window of the additional carrier phase measurements is configured by at least one of a network entity or a configuration entity. Different priority states of respective different positioning techniques are defined with respect to a PRS utilized for the different positioning techniques. A downlink-PRS used for performing RSTD measurements has a higher priority state relative to a priority state of the carrier phase measurements. The carrier phase measurements have a higher priority state relative to a priority state of a downlink-PRS used for performing RSTD measurements. The processor is configured to cause the apparatus to measure signal interference caused by shared downlink signals and channels; and transmit a third signaling of the measured signal interference to a configuration entity that determines a degradation to a downlink-PRS for downlink carrier phase measurements. For a carrier phase measurement configuration, a time gap between performing a downlink carrier phase measurement and a sidelink carrier phase measurement is minimized by using a joint downlink and sidelink measurement window.

The processor 904 of the device 902, such as a UE 104, may support wireless communication in accordance with examples as disclosed herein. The processor 904 includes at least one controller coupled with at least one memory, and is configured to or operable to cause the processor to receive a first signaling of one or more carrier phase positioning configurations that include at least one of PRS parameters or transmitter error types; and receive a second signaling of one or more PRS transmissions on which carrier phase measurements are performed based at least in part on the one or more carrier phase positioning configurations.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

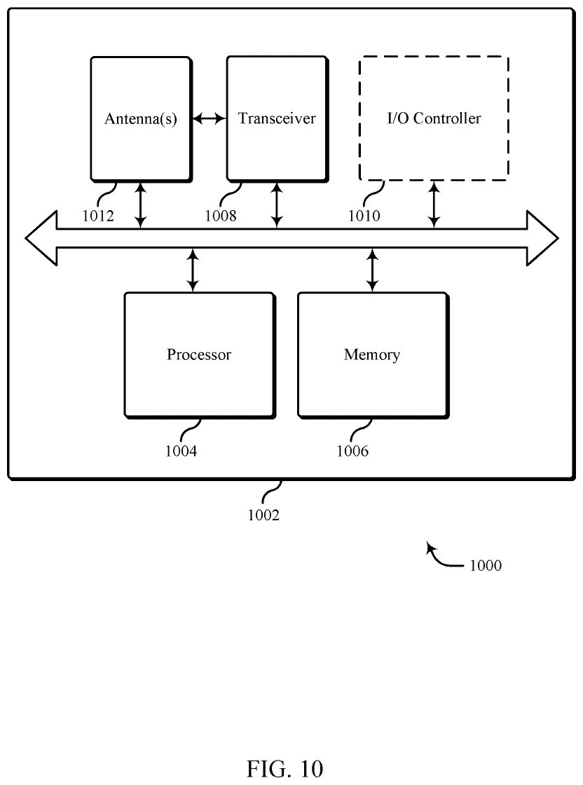

FIG. 10 illustrates an example of a block diagram 1000 of a device 1002 that supports carrier phase positioning configuration in accordance with aspects of the present disclosure. The device 1002 may be an example of a network entity 102 (e.g., configuration entity, a base station, gNB, network equipment (NE) or location server) as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006).

For example, the processor 1004 may support wireless communication at the device 1002 in accordance with examples as disclosed herein. The processor 1004 may be configured as or otherwise support a means for receiving a first signaling as integer ambiguity information of prior carrier phase measurements based at least in part on one or more PRS transmissions; and transmitting a second signaling as a carrier phase positioning configuration based at least in part on the integer ambiguity information, the carrier phase positioning configuration including at least one of PRS parameters, transmitter error types, an integer ambiguity, or integer ambiguity quality metrics.

Additionally, the processor 1004 may be configured as or otherwise support any one or combination of determining whether to transmit the second signaling of the carrier phase positioning configuration as one of a standalone carrier phase positioning configuration or a joint carrier phase positioning configuration. The carrier phase positioning configuration includes PRS resources to perform at least one of uplink carrier phase measurements, downlink carrier phase measurements, or sidelink carrier phase measurements. The PRS parameters include at least one of a number of symbols, a RE offset, a PRS comb size, a periodicity, a muting pattern, repetitions, a subcarrier spacing, an integer ambiguity value range, an integer confidence interval, or carrier information. Carrier phase measurements are performed on PRS time-frequency resources that span at least one of one or more carriers, one or more BWPs, or one or more resource pools within a BWP. Bi-directional carrier phase measurements are based at least in part on the carrier phase measurements performed at a transmitter and a receiver in a single positioning session. The carrier phase measurements are based at least in part on a carrier frequency, subcarrier spacing, or a propagation delay of a received PRS. The transmitter error types include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. For a carrier phase measurement configuration, a time gap between performing a downlink carrier phase measurement and a sidelink carrier phase measurement is minimized by use of a joint downlink and sidelink measurement window.

For example, the processor 1004 may support wireless communication at the device 1002 in accordance with examples as disclosed herein. The processor 1004 may be configured as or otherwise support a means for transmitting a first signaling as a request for one or more SRS configurations to perform carrier phase measurements; receiving a second signaling as a response of the one or more SRS configurations to perform the carrier phase measurements at multiple network entities; and receiving a third signaling as UE transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin.

Additionally, the processor 1004 may be configured as or otherwise support any one or combination of transmitting a fourth signaling as an activation SRS transmission command for carrier phase to the multiple network entities; and transmitting a fifth signaling as a deactivation SRS transmission command upon completion of SRS transmission.

Additionally, or alternatively, the device 1002, in accordance with examples as disclosed herein, may include a processor and a memory coupled with the processor, the processor configured to cause the apparatus to: receive a first signaling as integer ambiguity information of prior carrier phase measurements based at least in part on one or more PRS transmissions; and transmit a second signaling as a carrier phase positioning configuration based at least in part on the integer ambiguity information, the carrier phase positioning configuration including at least one of PRS parameters, transmitter error types, an integer ambiguity, or integer ambiguity quality metrics.

Additionally, the wireless communication at the device 1002 may include any one or combination of the processor is configured to cause the apparatus to determine whether to transmit the second signaling of the carrier phase positioning configuration as one of a standalone carrier phase positioning configuration or a joint carrier phase positioning configuration. The carrier phase positioning configuration includes PRS resources to perform at least one of uplink carrier phase measurements, downlink carrier phase measurements, or sidelink carrier phase measurements. The carrier phase positioning configuration includes at least one of SRS resources to perform uplink carrier phase measurements, downlink positioning reference signal (DL-PRS) resources to perform downlink carrier phase measurements, or sidelink positioning reference signal (SL-PRS) resources to perform sidelink carrier phase measurements. The PRS parameters include at least one of a number of symbols, a RE offset, a PRS comb size, a periodicity, a muting pattern, repetitions, a subcarrier spacing, an integer ambiguity value range, an integer confidence interval, or carrier information. Carrier phase measurements are performed on PRS time-frequency resources that span at least one of one or more carriers, one or more BWPs, or one or more resource pools within a BWP. Bi-directional carrier phase measurements are based at least in part on the carrier phase measurements performed at a transmitter and a receiver in a single positioning session. The carrier phase measurements are based at least in part on a carrier frequency, subcarrier spacing, or a propagation delay of a received PRS. The transmitter error types include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. A carrier phase measurement configuration, a time gap between performing a downlink carrier phase measurement and a sidelink carrier phase measurement is minimized by use of a joint downlink and sidelink measurement window.

Additionally, or alternatively, the device 1002, in accordance with examples as disclosed herein, may include a processor and a memory coupled with the processor, the processor configured to cause the apparatus to: transmit a first signaling as a request for one or more SRS configurations to perform carrier phase measurements; receive a second signaling as a response of the one or more SRS configurations to perform the carrier phase measurements at multiple network entities; and receive a third signaling as UE transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin.

Additionally, the wireless communication at the device 1002 may include any one or combination of the processor is configured to cause the apparatus to transmit a fourth signaling as an activation SRS transmission command for carrier phase to the multiple network entities; and transmit a fifth signaling as a deactivation SRS transmission command upon completion of SRS transmission.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device 1002. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor 1004. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (i.e., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

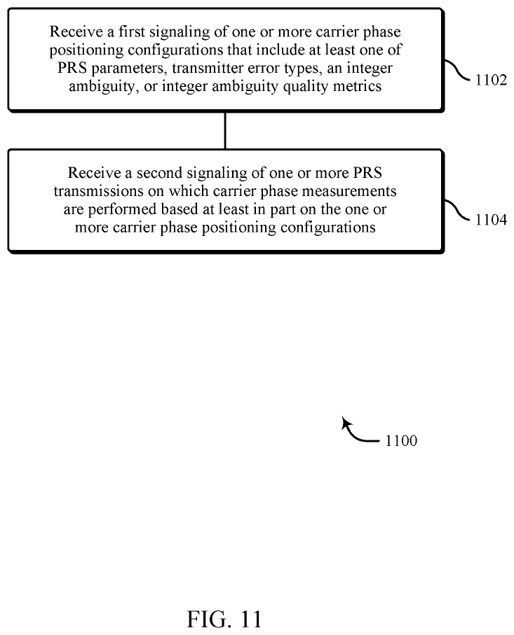

FIG. 11 illustrates a flowchart of a method 1100 that supports carrier phase positioning configuration in accordance with aspects of the present disclosure. The operations of the method 1100 may be implemented by a device or its components as described herein. For example, the operations of the method 1100 may be performed by a target UE (e.g., a UE 104) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1102, the method may include receiving a first signaling of one or more carrier phase positioning configurations that include at least one of PRS parameters, transmitter error types, an integer ambiguity, or integer ambiguity quality metrics. The operations of 1102 may be performed in accordance with examples as described herein. In some implementations, aspects of the operations of 1102 may be performed by a device as described with reference to FIG. 1.

At 1104, the method may include receiving a second signaling of one or more PRS transmissions on which carrier phase measurements are performed based at least in part on the one or more carrier phase positioning configurations. The operations of 1104 may be performed in accordance with examples as described herein. In some implementations, aspects of the operations of 1104 may be performed by a device as described with reference to FIG. 1.

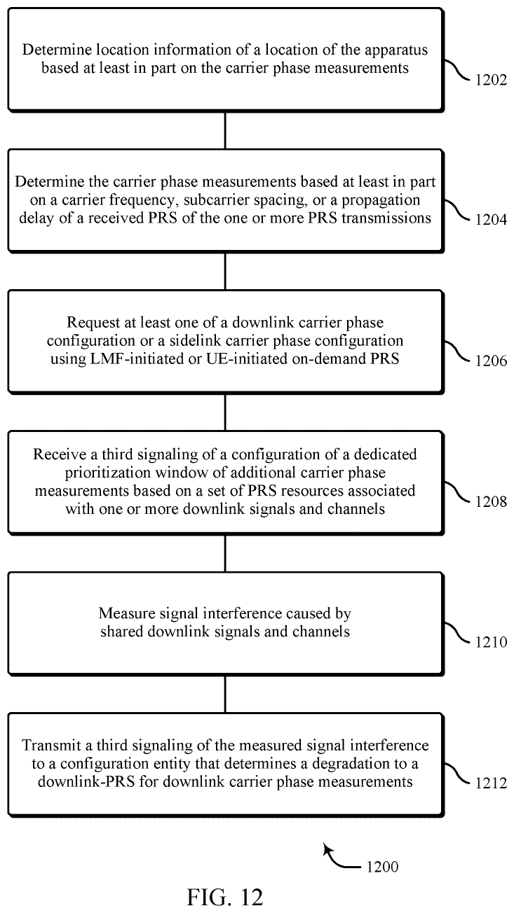

FIG. 12 illustrates a flowchart of a method 1200 that supports carrier phase positioning configuration in accordance with aspects of the present disclosure. The operations of the method 1200 may be implemented by a device or its components as described herein. For example, the operations of the method 1200 may be performed by target UE (e.g., a UE 104) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1202, the method may include determining location information of a location of the apparatus based at least in part on the carrier phase measurements. The operations of 1202 may be performed in accordance with examples as described herein. In some implementations, aspects of the operations of 1202 may be performed by a device as described with reference to FIG. 1.

At 1204, the method may include determining the carrier phase measurements based at least in part on a carrier frequency, subcarrier spacing, or a propagation delay of a received PRS of the one or more PRS transmissions. The operations of 1204 may be performed in accordance with examples as described herein. In some implementations, aspects of the operations of 1204 may be performed by a device as described with reference to FIG. 1.

At 1206, the method may include requesting at least one of a downlink carrier phase configuration or a sidelink carrier phase configuration using LMF-initiated or UE-initiated on-demand PRS. The operations of 1206 may be performed in accordance with examples as described herein. In some implementations, aspects of the operations of 1206 may be performed by a device as described with reference to FIG. 1.

At 1208, the method may include receiving a third signaling of a configuration of a dedicated prioritization window of additional carrier phase measurements based on a set of PRS resources associated with one or more downlink signals and channels. The operations of 1208 may be performed in accordance with examples as described herein. In some implementations, aspects of the operations of 1208 may be performed by a device as described with reference to FIG. 1.

At 1210, the method may include measuring signal interference caused by shared downlink signals and channels. The operations of 1210 may be performed in accordance with examples as described herein. In some implementations, aspects of the operations of 1210 may be performed by a device as described with reference to FIG. 1.

At 1212, the method may include transmitting a third signaling of the measured signal interference to a configuration entity that determines a degradation to a downlink-PRS for downlink carrier phase measurements. The operations of 1212 may be performed in accordance with examples as described herein. In some implementations, aspects of the operations of 1212 may be performed by a device as described with reference to FIG. 1.

FIG. 13 illustrates a flowchart of a method 1300 that supports carrier phase positioning configuration in accordance with aspects of the present disclosure. The operations of the method 1300 may be implemented by a device or its components as described herein. For example, the operations of the method 1300 may be performed by a network entity 102 (e.g., configuration entity) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1302, the method may include receiving a first signaling as integer ambiguity information of prior carrier phase measurements based at least in part on one or more PRS transmissions. The operations of 1302 may be performed in accordance with examples as described herein. In some implementations, aspects of the operations of 1302 may be performed by a device as described with reference to FIG. 1.

At 1304, the method may include transmitting a second signaling as a carrier phase positioning configuration based at least in part on the integer ambiguity information, the carrier phase positioning configuration including at least one of PRS parameters, transmitter error types, an integer ambiguity, or integer ambiguity quality metrics. The operations of 1304 may be performed in accordance with examples as described herein. In some implementations, aspects of the operations of 1304 may be performed by a device as described with reference to FIG. 1.

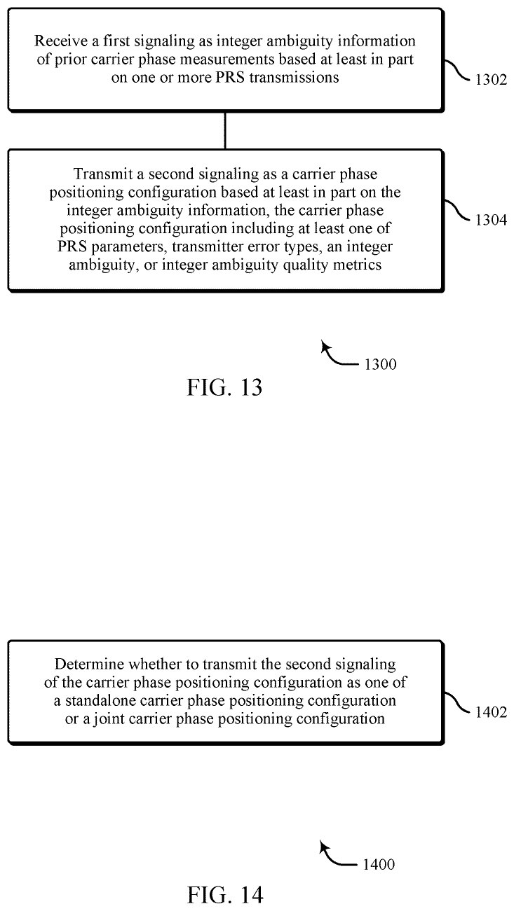

FIG. 14 illustrates a flowchart of a method 1400 that supports carrier phase positioning configuration in accordance with aspects of the present disclosure. The operations of the method 1400 may be implemented by a device or its components as described herein. For example, the operations of the method 1400 may be performed by a network entity 102 (e.g., configuration entity) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1402, the method may include determining whether to transmit the second signaling of the carrier phase positioning configuration as one of a standalone carrier phase positioning configuration or a joint carrier phase positioning configuration. The operations of 1402 may be performed in accordance with examples as described herein. In some implementations, aspects of the operations of 1402 may be performed by a device as described with reference to FIG. 1.

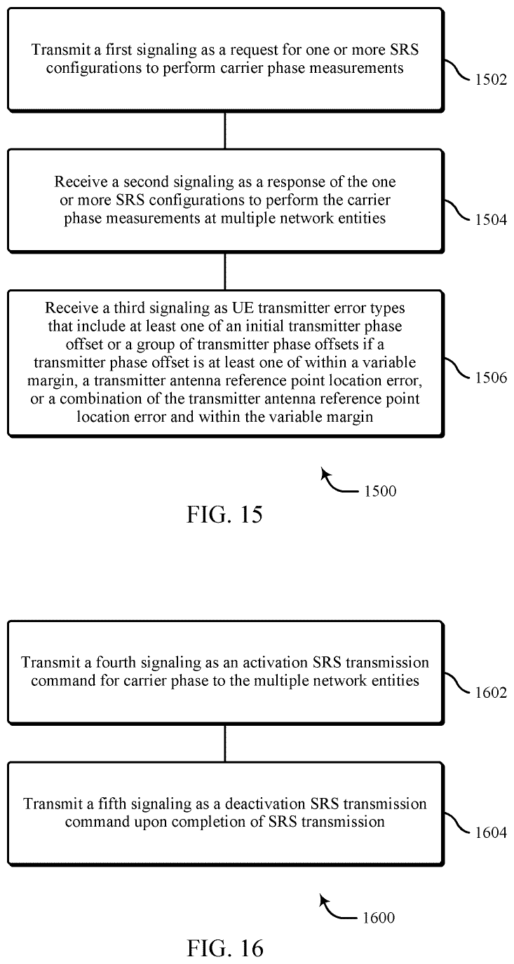

FIG. 15 illustrates a flowchart of a method 1500 that supports carrier phase positioning configuration in accordance with aspects of the present disclosure. The operations of the method 1500 may be implemented by a device or its components as described herein. For example, the operations of the method 1500 may be performed by a network entity 102 (e.g., a base station, gNB, or location server) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1502, the method may include transmitting a first signaling as a request for one or more SRS configurations to perform carrier phase measurements. The operations of 1502 may be performed in accordance with examples as described herein. In some implementations, aspects of the operations of 1502 may be performed by a device as described with reference to FIG. 1.

At 1504, the method may include receiving a second signaling as a response of the one or more SRS configurations to perform the carrier phase measurements at multiple network entities. The operations of 1504 may be performed in accordance with examples as described herein. In some implementations, aspects of the operations of 1504 may be performed by a device as described with reference to FIG. 1.

At 1506, the method may include receiving a third signaling as UE transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin. The operations of 1506 may be performed in accordance with examples as described herein. In some implementations, aspects of the operations of 1506 may be performed by a device as described with reference to FIG. 1.

FIG. 16 illustrates a flowchart of a method 1600 that supports carrier phase positioning configuration in accordance with aspects of the present disclosure. The operations of the method 1600 may be implemented by a device or its components as described herein. For example, the operations of the method 1600 may be performed by a network entity 102 (e.g., a base station, gNB, or location server) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1602, the method may include transmitting a fourth signaling as an activation SRS transmission command for carrier phase to the multiple network entities. The operations of 1602 may be performed in accordance with examples as described herein. In some implementations, aspects of the operations of 1602 may be performed by a device as described with reference to FIG. 1.

At 1604, the method may include transmitting a fifth signaling as a deactivation SRS transmission command upon completion of SRS transmission. The operations of 1604 may be performed in accordance with examples as described herein. In some implementations, aspects of the operations of 1604 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a first signaling of one or more carrier phase positioning configurations that include one or more positioning reference signal (PRS) parameters; and
receive a second signaling of one or more PRS transmissions on which carrier phase measurements are performed based at least in part on the one or more carrier phase positioning configurations.

2. The UE of claim 1, wherein the at least one processor is operable to cause the UE to determine location information of a location of the UE based at least in part on the carrier phase measurements.

3. The UE of claim 1, wherein the one or more carrier phase positioning configurations include PRS resources to perform at least one of uplink carrier phase measurements, downlink carrier phase measurements, or sidelink carrier phase measurements according to a measured first arrival path.

4. The UE of claim 1, wherein the one or more PRS parameters include at least one of a number of symbols, a resource element (RE) offset, a PRS comb size, a periodicity, a muting pattern, repetitions, a subcarrier spacing, an integer ambiguity value range, an integer confidence interval, or carrier information.

5. The UE of claim 1, wherein the carrier phase measurements are associated with measurements performed on PRS time-frequency resources that span one or more carriers, one or more bandwidth parts (BWPs), or one or more resource pools within a BWP.

6. The UE of claim 1, wherein bi-directional carrier phase measurements are based at least in part on the carrier phase measurements performed at a transmitter and a receiver in a single positioning session.

7. The UE of claim 1, wherein the at least one processor is operable to cause the UE to determine the carrier phase measurements based at least in part on a carrier frequency, subcarrier spacing, or a propagation delay of a received PRS of the one or more PRS transmissions.

8. The UE of claim 1, wherein the one or more carrier phase positioning configurations include transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin.

9. The UE of claim 1, wherein the at least one processor is operable to cause the UE to request at least one of a downlink carrier phase configuration or a sidelink carrier phase configuration using location management function (LMF)-initiated or user equipment (UE)-initiated on-demand PRS.

10. The UE of claim 1, wherein a configuration of a window of the carrier phase measurements is configured by at least one of a network entity or a configuration entity.

11. (canceled)

12. A network equipment (NE) for wireless communication, comprising:
at least one memory; and
at least one processor coupled with the at least one memory and configured to cause the NE to:
receive a first signaling as integer ambiguity information of prior carrier phase measurements based at least in part on one or more positioning reference signal (PRS) transmissions; and
transmit a second signaling as a carrier phase positioning configuration based at least in part on the integer ambiguity information, the carrier phase positioning configuration including one or more PRS parameters.

13. The NE of claim 12, wherein the at least one processor is operable to cause the NE to determine whether to transmit the second signaling of the carrier phase positioning configuration as one of a standalone carrier phase positioning configuration or a joint carrier phase positioning configuration.

14. The NE of claim 12, wherein the carrier phase positioning configuration includes at least one of sounding reference signal (SRS) resources to perform uplink carrier phase measurements, downlink positioning reference signal (DL-PRS) resources to perform downlink carrier phase measurements, or sidelink positioning reference signal (SL-PRS) resources to perform sidelink carrier phase measurements.

15. The NE of claim 12, wherein the one or more PRS parameters include at least one of a number of symbols, a resource element (RE) offset, a PRS comb size, a periodicity, a muting pattern, repetitions, a subcarrier spacing, an integer ambiguity value range, an integer confidence interval, or carrier information.

16. The NE of claim 12, wherein carrier phase measurements are performed on PRS time-frequency resources that span at least one of the one or more carriers, one or more bandwidth parts (BWPs), or one or more resource pools within a BWP.

17. The NE of claim 12, wherein the carrier phase positioning configuration includes transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin.

18. The NE of claim 12, wherein, for a carrier phase measurement configuration, a time gap between performing a downlink carrier phase measurement and a sidelink carrier phase measurement is minimized by use of a joint downlink and sidelink measurement window.

19. A network equipment (NE) for wireless communication, comprising:
at least one memory; and
at least one processor coupled with the at least one memory and operable to cause the NE to:
transmit a first signaling as a request for one or more sounding reference signal (SRS) configurations to perform carrier phase measurements;
receive a second signaling as a response of the one or more SRS configurations to perform the carrier phase measurements at multiple network entities; and
receive a third signaling as user equipment (UE) transmitter error types that include at least one of an initial transmitter phase offset or a group of transmitter phase offsets if a transmitter phase offset is at least one of within a variable margin, a transmitter antenna reference point location error, or a combination of the transmitter antenna reference point location error and within the variable margin.

20. The NE of claim 19, wherein a configuration of a window of the carrier phase measurements is configured by at least one of the NE or a configuration entity.

21. A method performed by a user equipment (UE), the method comprising:
receiving a first signaling of one or more carrier phase positioning configurations that include one or more positioning reference signal (PRS) parameters; and
receiving a second signaling of one or more PRS transmissions on which carrier phase measurements are performed based at least in part on the one or more carrier phase positioning configurations.
